(19) United States
(12) Patent Application Publication
(10) Pub. No.: US 2026/0145603 A1
(43) Pub. Date: May 28, 2026

(54) ADJUSTABLE ARMREST APPARATUS AND METHOD THEREOF

(71) Applicant: Brian Bouchard, Algonquin, IL (US)

(72) Inventor: Brian Bouchard, Algonquin, IL (US)

(21) Appl. No.: 19/401,230

(22) Filed: Nov. 25, 2025

Related U.S. Application Data
(60) Provisional application No. 63/724,424, filed on Nov. 25, 2024.

(51) Int. Cl. B60N 2/75; B60R 13/02

(52) U.S. Cl. CPC B60N 2/78; B60N 2/767; B60N 2/77; B60R 13/0243

(57) ABSTRACT

An adjustable armrest apparatus may comprise an adjustable frame having a top member, a middle member, and a bottom member. The middle member may be positioned substantially perpendicular to the top member and the bottom member. The top member and the bottom member may be substantially parallel to each other. A support pad may be positioned on the bottom member. A dual adjustment mechanism may be configured to adjust both height and length of the apparatus. The dual adjustment mechanism may include an adjustable rail within the middle member. The top member may be coupled to a top end of the middle member. The bottom member may be coupled to a bottom end of the middle member. The top member and the bottom member may each protrude outwardly from the middle member in opposite directions relative to one another. The adjustable rail may be operated via a twist knob mechanism. The dual adjustment mechanism may be configured to move the top member and the bottom member vertically to adjust the apparatus at a desired height.

### CROSS-REFERENCE TO RELATED APPLICATIONS

This application claims the benefit of U.S. Provisional Ser. No. 63/724,424 , filed Nov. 25, 2024, the entire contents of which are incorporated by reference herein.

### FIELD OF THE INVENTION

This disclosure relates generally to armrest apparatus. More particularly, this disclosure relates to an adjustable armrest apparatus and method specifically designed to provide support to an arm of a user within a vehicle.

### BACKGROUND

The following description of the background is provided simply as an aid to understanding the disclosure and is not admitted to describe or constitute prior art to the disclosure.

Currently there are a number of solutions for resting an arm on a vehicle door. One of these solutions attempts to utilize a cushioned cover, but this solution fails to meet the needs of the market because the cover is not adjustable. Another solution attempts to use a vehicle door window ledge, but this solution is similarly unable to meet the needs of the market because the door ledge could be too high or too low.

It would be advantageous to have an improved apparatus that can be adjusted and expandable to create a support armrest at a desired position. Furthermore, it would also be advantageous to have an apparatus that can be couplable to various types of walls within a vehicle. Still further, it would be advantageous to have an apparatus that can be portable.

### BRIEF OVERVIEW

The present disclosure may address one or more of the problems and deficiencies of existing solutions. However, it is contemplated that the disclosure may prove useful in addressing other problems and deficiencies in a number of technical areas. Therefore, the claimed subject matter should not necessarily be construed as limited to addressing any of the particular problems or deficiencies discussed herein.

The systems and methods disclosed herein may provide one or more technical effects and advantages. Various embodiments may provide some, all, or none of these advantages. Other technical effects and advantages may be readily apparent to one skilled in the art from the figures, descriptions, and claims included herein.

In one aspect, an adjustable armrest apparatus may include an adjustable frame, a support pad, and a dual adjustment mechanism for both height and length. The apparatus may be configured to be couplable to a wall within a vehicle and adjusted as desired by a user to rest their arm onto a top surface of the support pad.

Resting one's arm on a vehicle door while driving or as a passenger can sometimes be uncomfortable. The door may be positioned too far or too high, making it hard to find a position for comfort. Traditional armrests on the market are not adjustable, leaving this issue unresolved. The apparatus may be configured to provide adjustable length and/or height to vehicle doors to facilitate a user to rest their arm at a desired and comfortable position.

The features, functions, and advantages that have been discussed may be achieved independently in various embodiments or may be combined in yet other embodiments, further details of which can be seen with reference to the following description and drawings. Nothing in this section should be construed as limiting the scope of the disclosure or claims.

### BRIEF DESCRIPTION OF THE DRAWINGS

The disclosure may be better understood from the following description of exemplary embodiments together with reference to the accompanying drawings, in which:

FIG. 1 may be a front perspective view illustration of an exemplary embodiment of the apparatus when installed in a vehicle;

FIG. 2 may be a front view illustration of an exemplary embodiment of the apparatus when installed in a vehicle;

FIG. 3 may be a front view illustration of an exemplary embodiment of the apparatus;

FIG. 4 may be a back view illustration of an exemplary embodiment of the apparatus;

FIG. 5 may be a left side view illustration of an exemplary embodiment of the apparatus;

FIG. 6 may be a right side view illustration of an exemplary embodiment of the apparatus;

FIG. 7 may be a top view illustration of an exemplary embodiment of the apparatus;

FIG. 8 may be a bottom view illustration of an exemplary embodiment of the apparatus;

FIG. 9 may be a front perspective view illustration of an exemplary embodiment of the apparatus;

FIG. 10 may be a back perspective view illustration of an exemplary embodiment of the apparatus;

FIG. 11 may be a front perspective view illustration of the adjustment knobs of an exemplary embodiment of the apparatus;

FIG. 12 may be a side view illustration showing angular adjustment capability;

FIG. 13 may be a top view illustration showing dimensional proportions;

FIG. 14 may be a front view illustration showing attachment configuration;

FIG. 15 may be an isometric view illustration showing structural relationships;

FIG. 16 may be a perspective view illustration showing component assembly;

FIG. 17 may be a side view illustration showing support configuration;

FIG. 18 may be an exploded view illustration showing component separation;

FIG. 19 may be a side view illustration showing angular positioning;

FIG. 20 may be a view illustration showing pivot mechanism;

FIG. 21 may be a view illustration showing joint configuration;

FIG. 22 may be a view illustration showing assembly relationship;

FIG. 23 may be a view illustration showing component detail;

FIG. 24 may be a view illustration showing adjustment knobs detail; and

FIG. 25 may be a view illustration showing mounting configuration.

The drawings may not be to scale. The drawings may be merely schematic representations, not intended to portray specific parameters. The drawings may be intended to depict exemplary embodiments, and therefore should not be considered as limiting the scope of the disclosure. In the drawings, like numbering may represent like elements.

### DETAILED DESCRIPTION

The following description is provided as an enabling teaching. To this end, those skilled in the relevant art will recognize and appreciate that many changes can be made to the various embodiments described, while still obtaining the beneficial results. It will also be apparent that some of the desired benefits can be obtained by selecting some of the features without utilizing other features. Accordingly, those who work in the art will recognize that many modifications and adaptations are possible and can even be desirable in certain circumstances and are a part of the disclosure. Therefore, it is to be understood that this disclosure may be practiced other than as specifically described herein. At the same time, however, many of the features described herein may be used together to form uniquely beneficial combinations.

Furthermore, those skilled in the art will understand that the embodiments may include various features which may be used separately and/or in combination with other features. The embodiments described herein are not intended to be limiting, and those skilled in the art will recognize that various modifications and variations may be made without departing from the spirit and scope of the disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

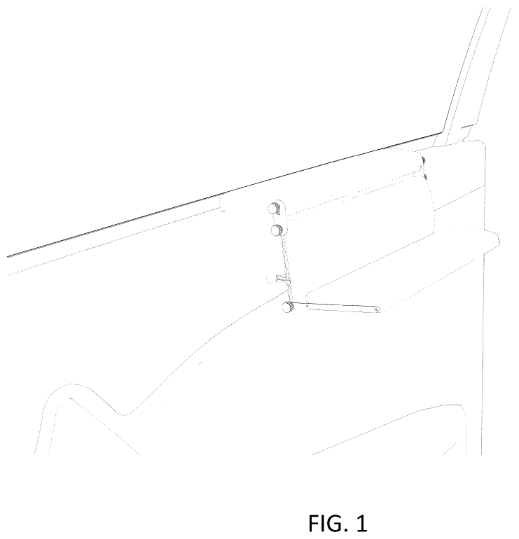

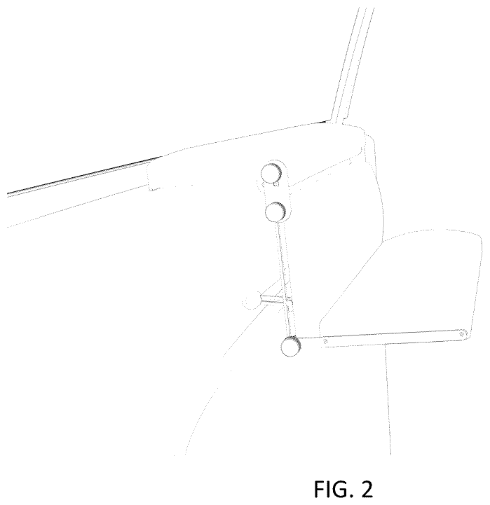

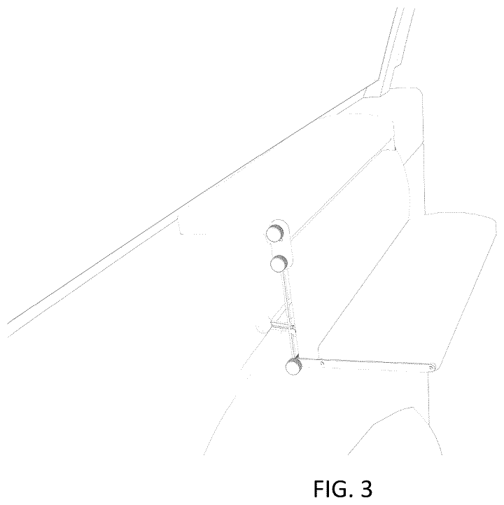

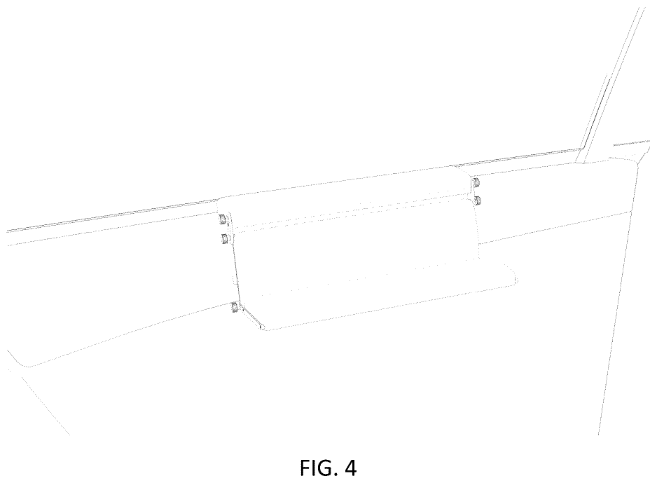

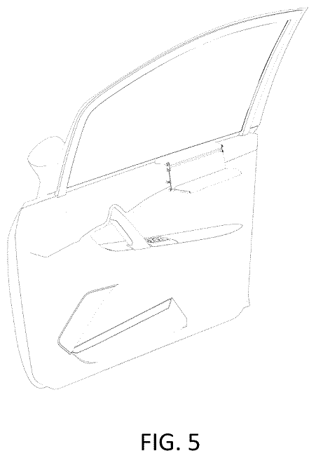

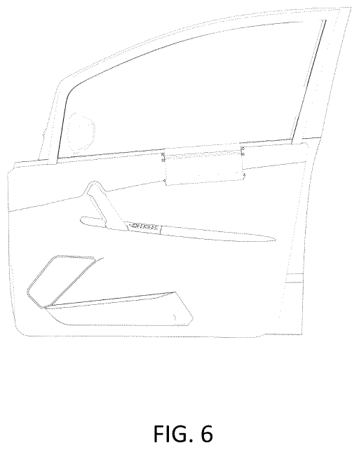

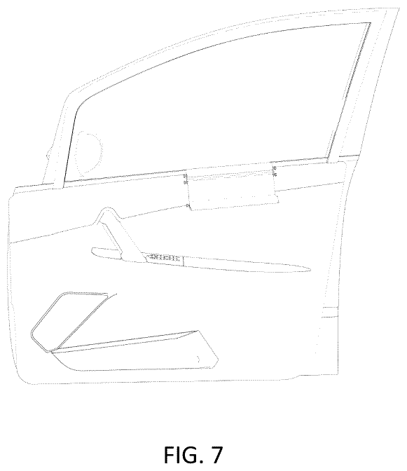

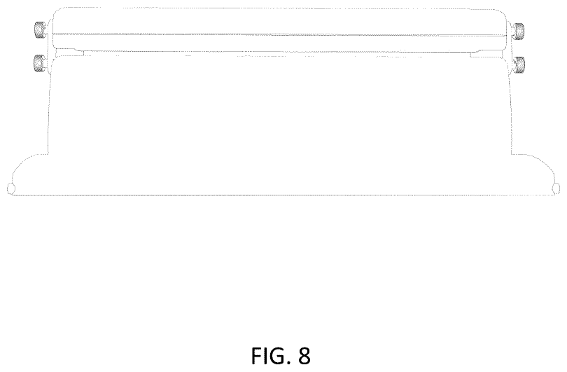

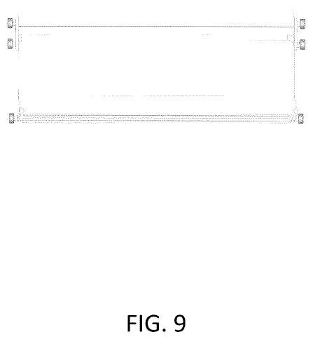

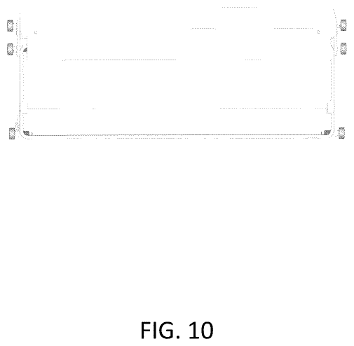

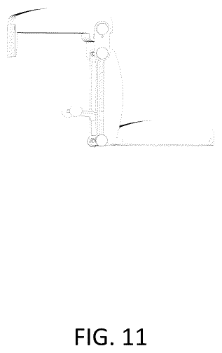

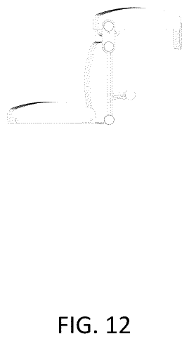

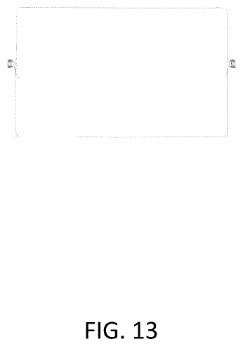

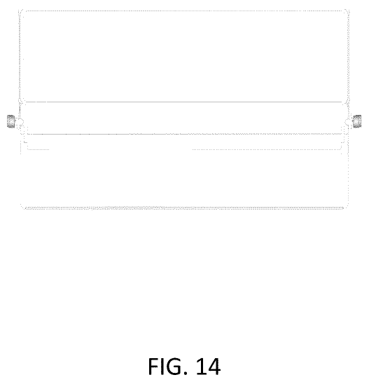

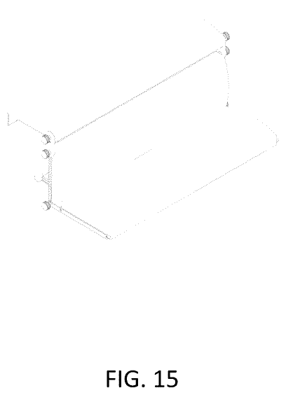

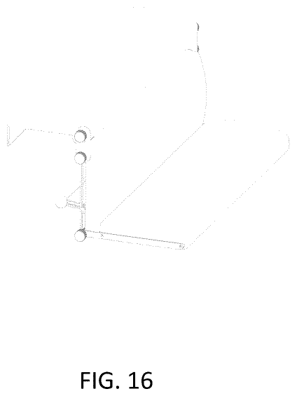

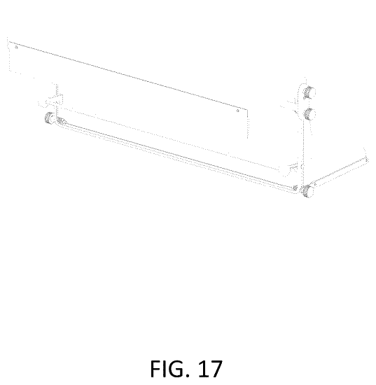

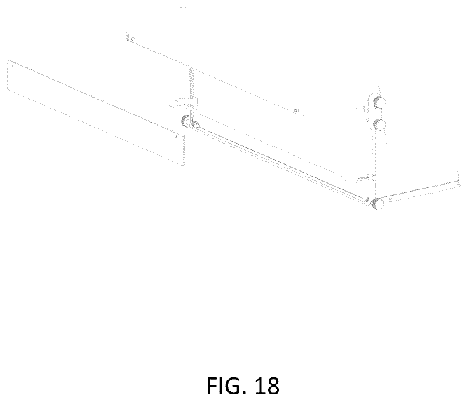

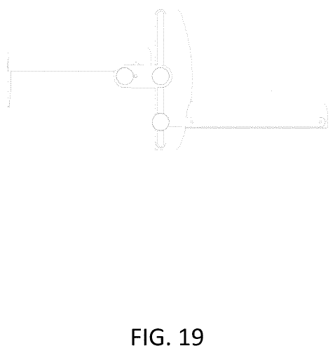

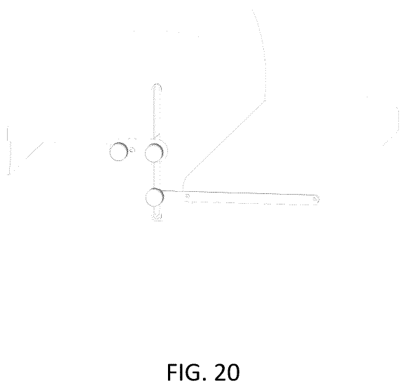

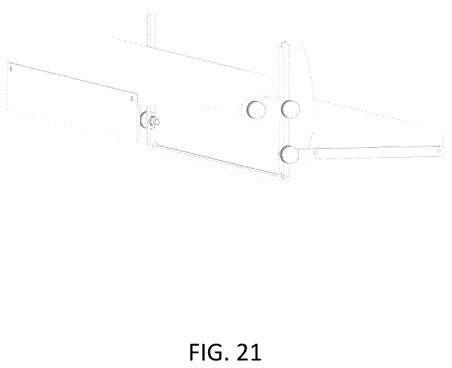

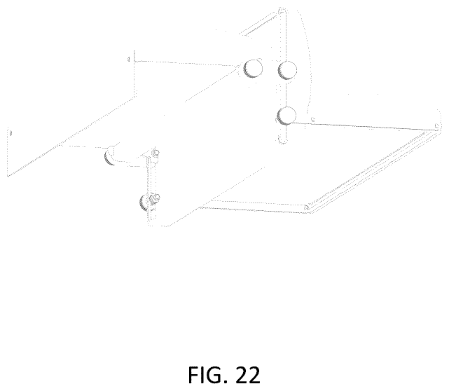

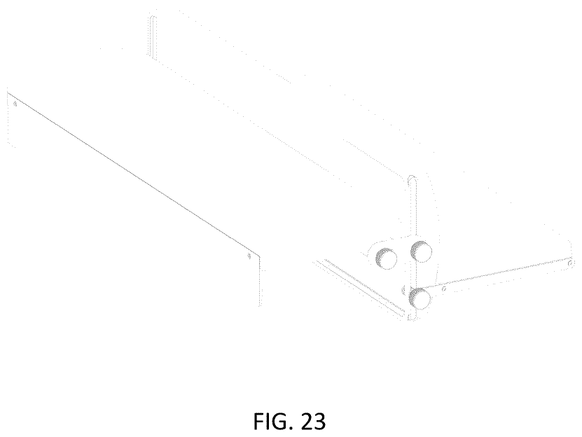

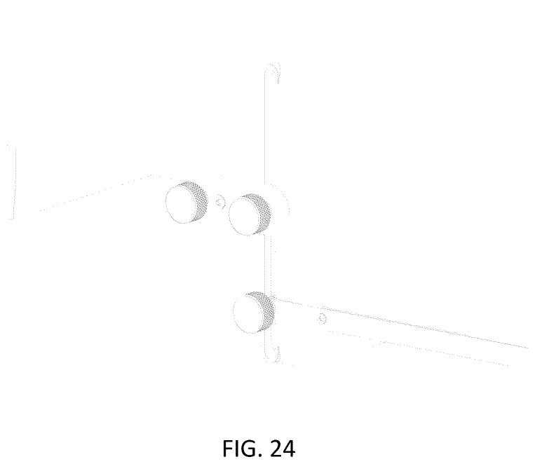

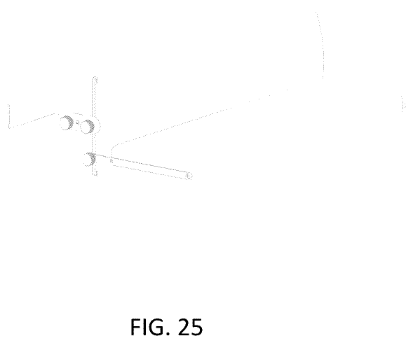

Referring now to FIGS. 1-25, various views of an adjustable armrest apparatus 10 according to exemplary embodiments are shown. The apparatus 10 may generally comprise an adjustable frame 20, a support pad 30, and a dual adjustment mechanism 40 for both height and length adjustment. The adjustable frame 20 may have three members movably coupled to each other. A middle member 22 may be coupled between a bottom member 24 and a top member 26.

The middle member 22 may be positioned substantially perpendicular to the bottom member 24 and the top member 26. The top member 26 and the bottom member 24 may be substantially parallel to each other. The top member 26 may be coupled to a top end of the middle member 22. The bottom member 24 may be coupled to a bottom end of the middle member 22. The top member 26 and the bottom member 24 may each protrude outwardly from the middle member 22 in opposite directions in relation to one another.

The middle member 22 may comprise an adjustable rail 50. The adjustable rail 50 may be operated via an adjustable twist knob mechanism 52 or any other suitable means. The dual adjustment mechanism 40 may be configured to move the top member 26 and/or bottom member 24 up or down to adjust the apparatus 10 at a desired height.

In some embodiments, the apparatus 10 may further comprise an angular adjustable attachment 60 between the middle member 22 and the top member 26. The angular adjustable attachment 60 may be configured to facilitate an angular movement of the middle member 22 around the top member 26. This may allow a user to adjust the length and angle of the bottom member 24 to better find a comfortable position to rest their arm.

The apparatus 10 may be configured to be couplable to a wall within a vehicle and adjusted as desired by a user to rest their arm onto a top surface of the bottom member 24. The apparatus 10 may be removably couplable to a door panel 70 of a vehicle's door via the top member 26. The top member 26 may have a trim insert 72 to facilitate a secure fit within a window trim 74.

The apparatus 10 may be made of various types of lightweight and durable materials. The apparatus 10 may be constructed from lightweight metal or plastic materials. The bottom member 24 may be covered with a cushion pad 32 for comfortable rest of the arm of the user. The middle member 22 and top member 26 may also be covered with cushion pads for extra comfort.

The adjustable rail 50 may enable vertical movement of the top member 26 and/or bottom member 24 relative to the middle member 22. The twist knob mechanism 52 may provide user control over the position of the adjustable rail 50. The angular adjustable attachment 60 may allow rotational movement between the middle member 22 and the top member 26.

The support pad 30 may be positioned on a top surface of the bottom member 24. The support pad 30 may provide cushioned support for a user's arm during vehicle operation. The dual adjustment mechanism 40 may enable simultaneous or independent adjustment of height and length parameters.

The trim insert 72 may be configured to interface with the window trim 74 of a vehicle door. The trim insert 72 may provide secure attachment while allowing for removal of the apparatus 10 when not needed. The door panel 70 may serve as the mounting surface for the apparatus 10.

The apparatus 10 may be portable and may be easily installed and removed from different vehicles. The lightweight construction may facilitate portability while maintaining structural integrity during use. The various adjustment mechanisms may allow customization for different users and vehicle configurations.

The adjustable frame 20 may provide structural support for all components of the apparatus 10. The three-member construction may enable multiple degrees of freedom for positioning adjustment. The coupling between members may be secure yet allow for desired movement during adjustment operations.

The angular adjustable attachment 60 may include pivot mechanisms that enable rotational movement. The attachment may include locking features to maintain selected angular positions during use. The attachment may be constructed to withstand repeated adjustment cycles.

Various embodiments may include additional features such as quick-release mechanisms, additional padding options, or alternative mounting configurations. The apparatus 10 may be adapted for use with different vehicle types and door configurations. The adjustment ranges may be optimized for typical user anthropometric requirements.

The apparatus 10 may address the limitations of existing armrest solutions by providing adjustability in multiple dimensions. The height adjustment capability may accommodate users of different statures. The length adjustment capability may address varying distances between the user and the door surface.

While various embodiments have been described above, it should be understood that they have been presented by way of example only, and not limitation. It will be apparent to persons skilled in the relevant art that various changes in form and detail can be made therein without departing from the spirit and scope of the disclosure. Thus, the breadth and scope should not be limited by any of the above-described exemplary embodiments, but should be defined only in accordance with the following claims and their equivalents.

What is claimed is:

1. An adjustable armrest apparatus comprising:
an adjustable frame having a top member, a middle member, and a bottom member, wherein the middle member is positioned substantially perpendicular to the top member and the bottom member, and wherein the top member and the bottom member are substantially parallel to each other;
a support pad positioned on the bottom member; and
a dual adjustment mechanism configured to adjust both height and length of the apparatus, wherein the dual adjustment mechanism includes an adjustable rail within the middle member.

2. The adjustable armrest apparatus of claim 1, wherein the top member is coupled to a top end of the middle member and the bottom member is coupled to a bottom end of the middle member.

3. The adjustable armrest apparatus of claim 1, wherein the top member and the bottom member each protrude outwardly from the middle member in opposite directions relative to one another.

4. The adjustable armrest apparatus of claim 1, wherein the adjustable rail is operated via a twist knob mechanism.

5. The adjustable armrest apparatus of claim 1, wherein the dual adjustment mechanism is configured to move the top member and the bottom member vertically to adjust the apparatus at a desired height.

6. The adjustable armrest apparatus of claim 1, further comprising an angular adjustable attachment between the middle member and the top member.

7. The adjustable armrest apparatus of claim 6, wherein the angular adjustable attachment is configured to facilitate angular movement of the middle member relative to the top member.

8. An adjustable armrest system comprising:
a mounting mechanism configured to couple to a vehicle door;
an adjustable frame having three members movably coupled to each other;
a support surface positioned to receive a user's arm; and
a height adjustment mechanism configured to modify vertical positioning of the support surface.

9. The adjustable armrest system of claim 8, wherein the mounting mechanism includes a trim insert configured to interface with a window trim of the vehicle door.

10. The adjustable armrest system of claim 9, wherein the trim insert is interchangeable to accommodate different vehicle window trim designs.

11. The adjustable armrest system of claim 8, wherein the three members include a top member, a middle member, and a bottom member.

12. The adjustable armrest system of claim 11, wherein the middle member is positioned substantially perpendicular to the top member and the bottom member.

13. The adjustable armrest system of claim 8, wherein the height adjustment mechanism includes an adjustable rail and a twist knob mechanism.

14. The adjustable armrest system of claim 8, further comprising a soft rubber stabilizer coupled to the support surface, configured to provide stability against the vehicle door and adjust vertically or angularly.

15. The adjustable armrest system of claim 8, further comprising an angular adjustment mechanism configured to modify angular positioning of the support surface.

16. A method of adjusting an armrest apparatus comprising:
coupling an adjustable frame to a vehicle door, wherein the adjustable frame includes a top member, a middle member, and a bottom member;
operating a dual adjustment mechanism to modify height positioning of a support pad; and
adjusting angular positioning of the middle member relative to the top member.

17. The method of claim 16, wherein coupling the adjustable frame includes inserting a trim insert into a window trim of the vehicle door.

18. The method of claim 16, wherein operating the dual adjustment mechanism includes manipulating a twist knob mechanism to move an adjustable rail.

19. The method of claim 16, wherein adjusting angular positioning includes rotating the middle member around the top member via an angular adjustable attachment.

20. The method of claim 16, further comprising positioning a user's arm on the support pad after completing adjustments.
